(19) United States
(12) Patent Application Publication
(10) Pub. No.: US 2025/0315527 A1
(43) Pub. Date: Oct. 9, 2025

(54) METHODS AND SYSTEMS FOR PER-RESOURCE ANOMALY DETECTION

(71) Applicant: Alcion, Inc., Santa Clara, CA (US)

(72) Inventors: Zachary Rossman, San Clemente, CA (US); Eno Thereska, Cambridge (GB); Georgi Milkov Matev, San Francisco, CA (US)

(73) Assignee: Alcion, Inc., Santa Clara, CA (US)

(21) Appl. No.: 19/098,266

(22) Filed: Apr. 2, 2025

Related U.S. Application Data
(60) Provisional application No. 63/575,547, filed on Apr. 5, 2024.

(51) Int. Cl. G06F 21/56; G06F 21/55; G06F 21/80

(52) U.S. Cl. CPC G06F 21/565; G06F 21/554; G06F 21/80; G06F 2221/034

(57) ABSTRACT

Disclosed herein are system, method, and computer program product embodiments for detecting ransomware and creating ransomware incidents by way of analyzing for ransomware signals in a backup data stream on a file-by-file basis. The ransomware detection system comprises a ransomware detection engine that includes a tracking component. The tracking component may track the byte distribution and extension of a file from a backup data stream. Further, the tracking component may perform a ransomware analysis on the file and identify, using a machine learning model, that the file is encrypted by ransomware based on an anomaly score and a confidence threshold. Subsequently, the tracking component may create a ransomware incident based on the identification that the file is encrypted by ransomware. Disclosed herein are additional embodiments directed towards training and updating a machine learning model within the ransomware detection engine.

### CROSS-REFERENCE TO RELATED APPLICATIONS

This application claims priority to U.S. Provisional Patent Application No. 63/575,547, filed on Apr. 5, 2024, which is incorporated by reference herein in its entirety.

### BACKGROUND

Organizations face increasingly frequent and sophisticated cyber-attacks. Early detection of cyber-attacks—such as ransomware—is critical to ensure a possible attack is adequately addressed. The more quickly a network administrator is alerted of a cyber-attack, the sooner the administrator can appropriately quarantine ransomware-affected systems and protect unencrypted data. Such responses are essential to reduce the effectiveness of a bad actor.

Conventional anomaly detection systems detect ransomware by analyzing data for particular ransomware signals—such as a file's entropy and extension. However, these conventional systems cannot adequately analyze data for ransomware signals and detect ransomware in a timely manner due to a variety of computational and practical reasons. For example, a common mechanism these systems use for ransomware detection is calculating file entropy. File entropy is correlated with the randomness of data in the file. High values of calculated entropy may reflect a file encrypted by ransomware whereas low values of calculated entropy may reflect a file not encrypted by ransomware. Conventional anomaly detection systems imperfectly utilize file entropy calculations to detect ransomware, leading to potentially greatly inadequate results.

Some conventional anomaly detection systems calculate file entropy through sampling. Specifically, these systems may calculate file entropy for a small subset of files. But this approach leaves substantial gaps in ransomware detection capabilities because ransomware strains often merely identify and encrypt the most critical files to reduce the footprint of suspicious activity. In addition to lacking in thoroughness, conventional anomaly detection systems often lack computational efficiency because they need to query for and then extract file data from persistent storage before analyzing files for ransomware signals. For example, these systems execute entropy calculations once a particular file backup data stream is completed. This process is costly both in terms of computational resources (e.g., processing cycles, memory, input/output (I/O) operations, etc.) and application programming interface (API) calls to the persistent storage service. Furthermore, these systems are impractical because the process of retrieving file data from persistent storage delays ransomware detection times. Simply, conventional anomaly detection systems do not address the computational and practical inefficiencies that plague an organization's ability to detect ransomware in a timely manner.

### BRIEF DESCRIPTION OF THE DRAWINGS

The accompanying drawings are incorporated herein and form a part of the specification.

FIG. 1A is a block diagram of an example network-based computing environment configured to detect ransomware in a file on a file-by-file basis, according to some embodiments.

FIG. 1B is a block diagram of an example of a ransomware detection system, according to some embodiments.

FIG. 2 is a flowchart illustrating an example method of operation for synchronously detecting a ransomware incident in a backup data stream, according to some embodiments.

FIG. 3 is a flowchart illustrating an example method for training a machine learning model during the detection of a ransomware incident, according to some embodiments.

FIG. 4 is a flowchart illustrating an example method for updating the machine learning models of a ransomware detection engine, according to some embodiments.

FIG. 5 is a flowchart illustrating an example method for training a machine learning model through client queries, according to some embodiments.

FIG. 6 is an example computer system useful for implementing various embodiments.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are method, system, and/or computer program product embodiments and/or combinations and sub-combinations thereof, for detecting a ransomware incident by way of analyzing ransomware signals in a backup data stream on a file-by-file basis.

Organizations are facing increasingly frequent and sophisticated ransomware attacks. Early detection is critical to cyber-attack responses. The sooner admins are alerted to an attack, the sooner they can isolate the ransomware-affected systems and protect any remaining unencrypted data; this, in turn, reduces the leverage of the bad actor.

Conventional anomaly detection systems do not address the computational and practical inefficiencies that plague an organization's ability to detect ransomware in a timely manner. As an example, a bad actor may gain access to an organization's file storage systems. Once the bad actor has such access, they may initiate a ransomware attack by encrypting a particular file or multiple files. The bad actor may hold the key to the encrypted files and demand a ransom payment to de-encrypt the victim's files to regain access. As a result, an organization may be placed in a difficult position because the encrypted ransomware files may be critical to its operation. The ability to quickly and effectively detect anomalous data access patterns in a file storage system will inhibit a bad actor's attempt to infiltrate and disrupt an organization's operations.

Many conventional anomaly detection systems cannot adequately detect ransomware in a timely manner due to a variety of computational and practical reasons. A common mechanism these systems use for ransomware detection is identifying and analyzing file attributes which provide information (the “signal(s)”) regarding the likelihood that the file was encrypted by ransomware, such as file extension and entropy of the file's bytes. File entropy may measure the randomness of data. Because ransomware often relies on encrypting a file's bytes, high values of calculated entropy may reflect a file encrypted by ransomware whereas low values of calculated entropy may reflect a file not encrypted by ransomware. Similarly, analyzing the file extension is useful for identifying ransomware activity because ransomware attacks usually add an atypical extension to files that have already been encrypted as a way to keep track of progress. Conventional anomaly detection systems imperfectly utilize signals like file extension and file entropy to detect ransomware, leading to greatly inadequate results. For example, conventional anomaly detection systems often use sampling when analyzing signals like file extension and file entropy. Specifically, these systems generally analyze these signals for a small subset of files. They do not check file extension and file entropy on a file-by-file basis, given the time and resource consumption such an approach would typically require. But this approach leaves substantial gaps in ransomware detection capabilities because ransomware strains often prioritize encrypting the most critical files to reduce the footprint of suspicious activity.

Other conventional anomaly detection systems analyze files for suspicious activity by querying persistent data storage. For example, these systems execute entropy calculations once a particular file backup data stream is completed. This is both computationally expensive to execute and impractical to implement. For example, these systems are computationally inefficient because they require querying persistent storage. Querying persistent storage is computationally expensive because it requires retrieving a file from a storage environment for the sole purpose of analyzing the file for signals indicative of ransomware. Additionally, these systems are impractical because retrieving files from persistent storage adds to the time delay to detect ransomware. It is imperative that organizations decrease their time to detection so as to minimize attackers' leverage which can be used to disrupt an origination's operations and hold essential files hostage for a hefty ransom.

Therefore, there is a need for comprehensive signal analysis for each file without querying and retrieving data from persistent storage to improve ransomware detection. Analyzing signals relevant to ransomware for each file without querying persistent storage improves upon the computational efficiency of ransomware detection systems by removing the need for retrieving file data from the persistent storage environment. This advantageously reduces the computer resources needed to detect ransomware among an organization's file storage environment. Additionally, such operations are substantially more practical because they may be executed before a ransomware-encrypted file is integrated into a file storage environment. This, in turn, reduces ransomware detection times and the leverage a bad actor may have on an organization's operations.

In some embodiments, the methods and systems described herein execute a ransomware detection engine within a computing environment. The computing environment may refer to an environment designated for data backup operations. The computing environment may refer to a mobile device, a laptop computer, a desktop computer, grid-computing resources, a virtualized computing resource, cloud computing resources, peer-to-peer distributed computing devices, a server, a server farm, or a combination thereof. Execution of such methods and systems may result in improved levels of accuracy and computational cost efficiency in detecting ransomware. For example, executing a ransomware detection engine within the aforementioned computing environment—such as, but not limited to, a serverless cloud—computing environment-allows for the ransomware detection engine to track byte distribution as data is being streamed into the computing environment. By analyzing files for signals that are indicative of ransomware as data is streamed into the computing system, execution of the methods described herein advantageously increase the computational efficiency for ransomware detection and quarantining by eliminating or substantially eliminating additional queries to (and incurring additional response times, query costs) the computing environment.

In some embodiments, the ransomware detection system described herein includes a tracking component, which may execute an entropy calculation, file extension analysis, an anomaly detection algorithm, or a combination thereof. The system may additionally include a machine learning engine. The tracking component may be configured to communicate with the machine learning engine. In some embodiments, the machine learning engine may be within the tracking component and contain one or more machine learning models.

The tracking component may track byte distribution of data that is streamed into a computing environment such as, but not limited to, a data backup system. After the bytes are read, the tracking component may execute an entropy calculation based on the byte distribution. In some embodiments, the tracking component may execute a statistical test to determine if an observed distribution is statistically similar to an expected distribution. For example, in the case of perfectly random data stored on a file system and streamed into a data backup system, the entropy calculation would predict an equal occurrence of each byte value. The embodiments may be directed towards crypto-ransomware detection in which files are encrypted using probabilistically equal frequencies of byte values for expected distribution. The tracking component may use the entropy calculation to determine if there is a similar or substantially equal frequency of byte values between the expected distribution and the observed distribution. Quantifying the entropy of a file's byte content is valuable because the likelihood of a file being encrypted by ransomware has a strong correlation to the entropy of the file's bytes. For example, a probability a file being encrypted by ransomware may be directly correlated to the entropy of the file's bytes. The method may include determining a threshold level of entropy—also labeled as a confidence threshold—to identify output values less likely to be correlated with ransomware attacks.

The tracking component may track file extension of data that is streamed into a computing environment such as, but not limited to, a data backup system. The file extension(s) of streamed data may be compared with a predefined set of extensions that are known to be associated with ransomware attacks, including but not limited to “.lockbit” and “.zcrypt.” Identifying extensions that are known to be associated with ransomware attacks is valuable because the likelihood of a file being encrypted by ransomware often has a strong correlation to the presence of such extensions.

The tracking component may be configured to execute an anomaly detection algorithm in a manner that supports “online” learning. Many conventional machine learning models are trained to make inferences based on discrete processes. For example, once a machine learning model version is deployed, that model version cannot learn from new observations and makes inferences based on the static, pre-existing set of observations it was trained on. Observations may refer to a set of statistics of a file determined by the ransomware detection engine. These statistics may include, but are not limited to, the entropy of a file, the extension of a file, a flag indicating the file was deleted, altered, or replaced, or a combination thereof. Observations may also refer to a collection of statistics for multiple files including, but not limited to, a number of high-entropy files, a number of files with extensions known to be used in ransomware attacks, a number of deleted files, a number of altered or replaced files, or a combination thereof.

An “online” machine learning model may learn during execution of the model, which benefits both end users during execution and may eliminate the need to train, tune, and deploy new versions of the model. This greatly reduces the computational load, the accuracy of the model's inference capabilities, and the cost needed to improve those inference capabilities. Simply, the tracking component may collect data and provide the data as input to the model during execution to enable “online” learning of the existing machine learning models.

In some embodiments, the tracking component may be configured to efficiently prune outdated observations and machine learning models. For example, the tracking component may be configured to delete an observation from a memory component—including, but not limited to, a training data storage component—after a particular time period has elapsed (e.g., 30 days after the observation was determined), after a threshold number of observations has been exceeded (e.g., a 1000 total observation threshold), or a combination thereof. Similarly, the tracking component may be configured to prune an outdated machine learning model by deleting the model from a memory component—including, but not limited to, training data storage component and/or the computing environment—after a particular time period has elapsed (e.g., 30 days after the machine learning model was last updated), after a threshold number of models has been exceeded (e.g., 4 total models), or a combination thereof. These embodiments are exemplary and are not intended to limit this disclosure, as would be appreciated by one skilled in the art reading this disclosure.

Pruning stale observations and machine learning models allows the anomaly detection system to replace such observations and machine learning models with new observations and machine learning models generated based on newer file data. Specifically, this new data more accurately reflects resources' data access patterns and ensures that the cost of storing a serialized state of the training data and historical data is a fixed cost instead of one that grows unbounded as new observations and machine learning models are generated and stored. In this disclosure, the term “resource” may be used interchangeably with “user” or any other entity which is assigned ownership of data. However, other terms may be used to describe these terms, as will be recognized by a person skilled in the art reading this disclosure.

In some embodiments, the machine learning engine may execute one or more machine learning models. A machine learning model may employ a random cut forest algorithm(s). For example, in some embodiments, the machine learning engine may maintain multiple models for each resource that is analyzed for ransomware. Scoping each model to a specific resource may increase model accuracy because the data access patterns are expected to be consistent for each resource but are expected to deviate greatly between resources. Scoping each model to a specific resource may enhance tenant isolation. For example, observations from resources belonging to different tenants may not be pooled together to train the models. This, in turn, may provide a more robust ransomware detection algorithm tailored to the needs of a particular tenant and eliminates the possibility of a single tenant with atypical data access patterns from skewing the model for other tenants. Additionally, maintaining multiple models for a single resource means that the system may detect multiple types of ransomware attack profiles. This is important because ransomware strains can rely on different methods for encrypting files. For example, ransomware approaches can use an “in-place encryption” or “delete-and-replace encryption” approach. These approaches encrypt files through different operations and speeds. Implementing multiple models can take such differences into account and provide a more robust overall ransomware detection engine.

The machine learning engine may be configured to deploy a cost-efficient model architecture. Observations may be published (e.g., for incorporation into an “online” learning process) when a backup is run for a resource. For example, there may be three backups executed for each resource per day, resulting in three published observations per day. Such a workload is well-suited for the computing environment described above, such as, but not limited to, a serverless, cloud-based computing environment that can dynamically scale to meet the real-time needs of the ransomware detection application, resulting in significant computational cost savings (e.g., processing cycles, memory, input/output (I/O) operations, etc.).

In one embodiment, when a new observation for a resource is published, a lambda function is invoked which queries for the most recent version of the machine learning model dedicated to that resource. In some embodiments, the lambda function may refer to a serverless computing service configured to build and run applications and backend services within the particular computing environment described above. The computing service may be serverless in that the service dynamically provisions computing resources to meet the demands of requests, allowing for the application to efficiently handle high volumes of traffic without needing to overprovision computing resources during periods of medium or low traffic. The system may update the machine learning model by, for example, initializing a new version of the machine learning model based on the most recent observation, serializing the state of that newly versioned model into a text format (e.g., JavaScript Object Notation (JSON)) and then saving that text to persistent storage so that it can be used for inference operations in the future. The system may then publish an inference result generated by the anomaly detection system, in which the inference may indicate a likelihood of whether a particular file is encrypted by ransomware. Based on the inference, the system may save the new version of the machine learning model used for performing the anomaly detection algorithm state in the computing environment. In such embodiments, the cost of maintaining the model includes the cost of running the lambda function for tens of milliseconds and then paying for all model versions to be stored in cost-efficient cloud-based object storage, such as, but not limited to, a simple storage service offered through a web service interface. This system is less expensive than having a local computer or long-running server such as, but not limited to, an elastic container system (e.g., a Kubernetes-based service), that stores the anomaly detection system in memory since it eliminates the need to maintain those computing resources even during periods of low traffic and few determined observations.

In some embodiments, such an implementation allows for falling back to older versions of the anomaly detection algorithm if needed because older versions of the model are persisted in durable object storage. Outdated versions of the model may also be efficiently pruned from the cloud-based computer by leveraging commonly available object lifecycle policies. For example, an object lifecycle policy may define a particular time-frame in which a version of the machine learning model is to be active. Once the time frame expires, the machine learning model may be removed from the memory of the computing environment. This pruning ensures that the number of model versions persisted in object storage does not grow unbounded, further limiting costs. These embodiments are exemplary and are not intended to limit this disclosure, as would be appreciated by one skilled in the art reading this disclosure.

Therefore, the embodiments described herein may efficiently analyze each file for signals indicative of ransomware in a computing environment used for backing up files, rather than needing to analyze signal for a subset of files or through querying persistent storage. Each model may be trained on observations which are scoped to a specific resource. The system may maintain ensemble methods for each resource. In some embodiments, the system may optionally include a layer of human oversight before alerting customers to prevent false-positive inferences from reaching customers. If the tracking component believes a resource is likely a target of a ransomware attack, the system may publish the inference information and alert an on-call operator to manually review the incident. However, in the case of a true-positive inference result, the need for human intervention may delay the reporting of the ransomware incident. To address this, the embodiments may include, instead of or in addition to the human oversight, executing a modified version of the tracking component so that the entropy score for each file is compared to entropy scores for files of same type-which may be determined by the file extension-and file size. This advantageously reduces the likelihood that the system will output a false positive.

In some embodiments, this may include aggregating metadata (e.g., file size, extension, and entropy score) for each backed up file, bucketing the metadata by file size and file extension as well as calculating the mean, standard deviation, and number of observations in each bucket. Furthermore, the system may include an interface (e.g., an application programming interface (API)) which allows clients—like a system administrator—to query and use the model. The interface may display, to the client, a likelihood that a file with a given size, extension, and entropy score is encrypted by ransomware.

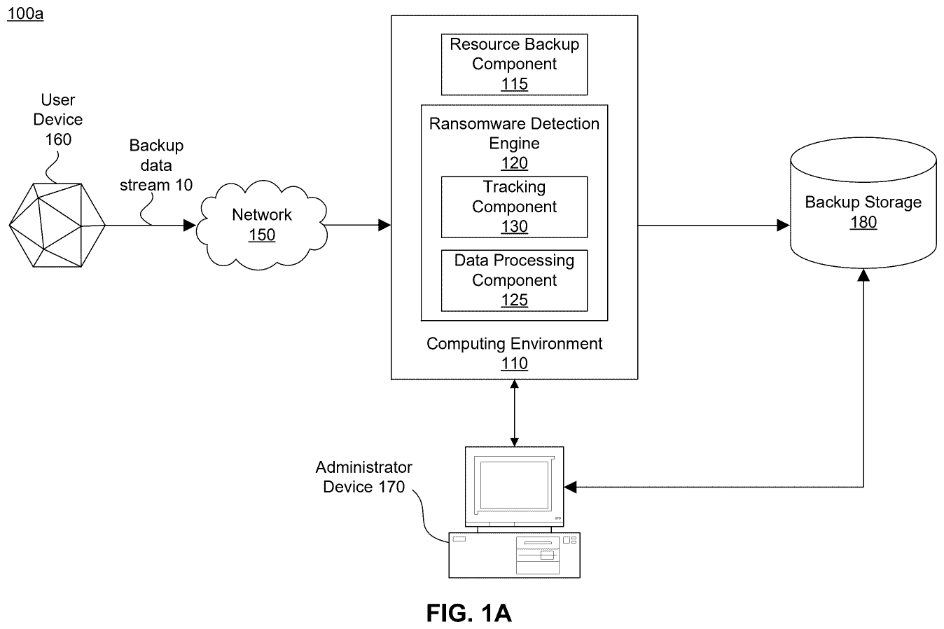

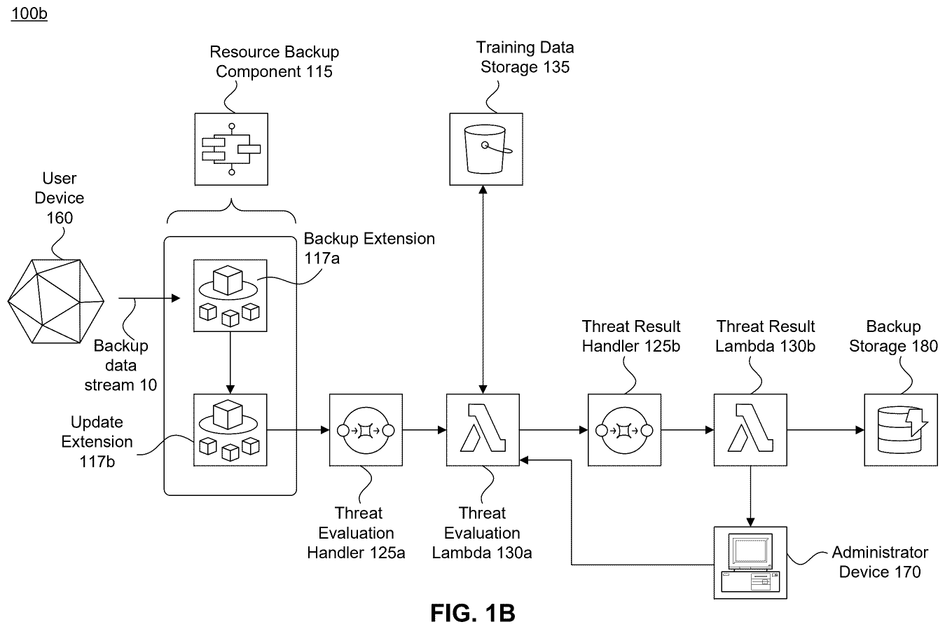

FIG. 1A illustrates a block diagram of example network-based computing environment 100a configured to detect ransomware in a file on a file-by-file basis, according to some embodiments. As shown in FIG. 1, system 100 includes user device 160, computing environment 110, administrator device 170, and backup storage 180. User device 160 may initiate backup data stream 10 to computing environment 110 via network 150. Backup data stream 10 may refer to a stream of one or more files sent to computing environment 110. Network 150 may comprise one or more networks such as local area networks (LANs), wide area networks (WANs), enterprise networks, the Internet, etc., and may include one or more of wired and/or wireless portions.

In some embodiments, backend computing infrastructure may be housed in the computing environment 110. The computing environment 110 can include server infrastructure. Additionally, the computing environment 110 can be a public or private cloud service. Examples of a public cloud service include, without limitation, Amazon Web Services (AWS), IBM Cloud, Oracle Cloud Solutions, Microsoft Azure Cloud, and Google Cloud. A private cloud can be implemented in the same manner as the aforementioned services but can be operated solely for a single organization. Alternatively, the backend computing infrastructure may not be a private cloud computing service but a server infrastructure housed in the company, institution, or similar organization's warehouse, data center, or other physical location.

In some embodiments, computing environment 110 can comprise a variety of centralized or decentralized computing devices. For example, the computing environment 110 may include a mobile device, a laptop computer, a desktop computer, grid-computing resources, a virtualized computing resource, cloud computing resources, peer-to-peer distributed computing devices, a server, a server farm, or a combination thereof. Computing environment 110 may be centralized in a single room, distributed across different rooms, distributed across different geographic locations, or embedded within a network. In some embodiments, the computing environment 110 can comprise several sub-components including, but not limited to, ransomware detection engine 120 and resource backup component 115, as illustrated in FIG. 1A. These sub-components may be housed within the same variety of centralized or decentralized computing devices forming the computing environment 110.

In some embodiments, computing environment 110 may house resource backup component 115. Resource backup component 115 may be the software, hardware, or combination thereof used to receive data from user device 160 streamed into computing environment 110 via backup data stream 10. For example, resource backup component 115 may be an API or comparable interface mechanism that allows files from user device 160 to be streamed into computing environment 110 via backup data stream 10. Additionally, resource backup component 115 may allow files to be streamed into computing environment 110 while ransomware detection engine 120 is being executed in parallel. This advantageously reduces the computational resources needed to process backup data stream 10. In some embodiments, resource backup component 115 may also be configured to publish a set of ransomware threat intelligence statistics to ransomware detection engine 120. For example, resource backup component 115 may determine, for the files of backup data stream 10, a number of high-entropy files, a number of files with extensions known to be associated with ransomware attacks, a number of deleted, altered, or replaced files, or a combination thereof. The statistics may also correspond to a specific file and include the entropy of the file, a flag indicating the file was deleted, altered, or replaced, or a combination thereof. These statistics may also be referred to as an observation.

In some embodiments, computing environment 110 may house ransomware detection engine 120. Ransomware detection engine 120 may, based on backup data stream 10 entering computing environment 110 from user device 160, detect whether files are encrypted by ransomware on a file-by-file basis. In some embodiments, ransomware detection engine 120 may include data processing component 125, tracking component 130, or a combination thereof.

In some embodiments, data processing component 125 may perform operations to receive and queue files being streamed into computing environment 110 from user device 160. For example, data processing component 125 may comprise of one or more queues, or comparable data structures, holding files from backup data stream 10 before being evaluated for ransomware by tracking component 130.

In some embodiments, tracking component 130 may perform operations relating to identifying whether a file has been encrypted by ransomware. Tracking component 130 may execute an entropy calculation and may further may execute an anomaly detection algorithm. Tracking component 130 may also include one or more machine learning engines. The one or more machine learning engines may include one or more machine learning models therein. The machine learning models may take the form of unsupervised learning methods, such as random cut forest algorithms. Tracking component 130 may use the machine learning engine to probabilistically evaluate and identify whether a file is encrypted by ransomware. In some alternate embodiments, the machine learning engine may be implemented externally to tracking component 130.

Tracking component 130 may a track byte distribution(s) as data is streamed into a computing environment 110 from backup data stream 10. After the bytes are read, tracking component 130 may execute an entropy calculation on the byte distribution. In one embodiment, tracking component 130 may execute a statistical test to determine if an observed byte distribution is statistically similar to the byte distribution that is typical of ransomware-encrypted files. For example, tracking component 130 may track the byte distribution of a file being streamed into computing environment 110 from backup data stream 10. By tracking the byte distribution of the file, tracking component 130 may calculate an entropy of the file, which may be reflected by a particular anomaly score. Tracking component 130 may also perform operations related to determining whether a file is encrypted by ransomware. To do so, tracking component 130 may perform additional operations, such as extracting a confidence threshold based on a set of file characteristics of a file and determining whether the anomaly score of the file is outside the confidence threshold.

Network 150 can connect the backend computing infrastructure to various external users or devices. For example, assuming environment 100a is used in the context of a computing environment 110, network 150 can connect user device 160 to computing environment 110. User device 160 can engage with computing environment 110 by sending a file or multiple files in backup data stream 10. User device 160 may then send the files of backup data stream 10 to computing environment 110 via network 150. The aforementioned case is exemplary. It will be used throughout this disclosure to illustrate the novel features of the disclosure. Environment 100a, however, may be used in other contexts, as will be recognized by a person skilled in the art reading this disclosure.

Network 150 refers to a telecommunications network, such as a wired or wireless network. Network 150 can span and represent a variety of networks and network topologies. For example, network 150 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 150. Cable, Ethernet, digital subscriber line (DSL), fiber optic lines, fiber to the home (FTTH), and plain old telephone service (POTS) are examples of wired communication that may be included in network 150. Further, network 150 can traverse a number of topologies and distances. For example, network 150 can include a direct connection, personal area network, local area network (LAN), metropolitan area network (MAN), wide area network (WAN), or a combination thereof.

In some embodiments, environment 100a may include backup storage 180. Backup storage 180 may refer to a database, cache, or comparable data repository. Backup storage 180 may receive a file after it is evaluated for ransomware. If the file is identified to not be encrypted by ransomware, tracking component 130 may transfer the file may to backup storage 180 in a designated repository, storage cluster, or similar sub-storage environment. If the file is identified to be encrypted by ransomware, tracking component 130 may direct the file to a different sub-storage component of backup storage 180. For example, the sub-component of backup storage 180 may be a quarantined file storage environment for files encrypted by ransomware.

In some embodiments, user device 160 may refer to a mobile device, a laptop computer, a desktop computer, grid-computing resources, a virtualized computing resource, cloud computing resources, peer-to-peer distributed computing devices, a server, a server farm, or a combination thereof. User device 160 is not limited to these types of embodiments, as will be recognized by a person skilled in the art reading this disclosure. User device 160 may initiate backup data stream 10. Backup data stream 10 may include a file or a plurality of files sent for backup storage through computing environment 110. As user device 160 initiates backup data stream 10, the files may be streamed through network 150. In some embodiments, the file may be reflected by, but is in no way limited to, a word document, excel document, PowerPoint, PDF, JPEG, MP4, or text file. The file type may not be limited to these exemplary embodiments, as will be recognized by a person skilled in the art reading this disclosure. Additionally, the files of backup data stream 10 may originate from an online, cloud-based productivity software platform, such as Microsoft 365.

In some embodiments, administrator device 170 may refer to a mobile device, a laptop computer, a desktop computer, grid-computing resources, a virtualized computing resource, cloud computing resources, peer-to-peer distributed computing devices, a server, a server farm, or a combination thereof. Administrator device 170 may receive files from computing environment 110 that have been identified to be encrypted by ransomware, have been identified to have a particular likelihood of ransomware, or a combination thereof. For example, administrator device 170 may send a file to computing environment 110 to query whether the file has been encrypted by ransomware or determine a likelihood that the file has been encrypted by ransomware. Administrator device 170 may also receive ransomware incidents created by computing environment 110. For example, computing environment 110 may send an alert to administrator device 170 that particular file has been encrypted by ransomware and particular recommended actions that should be taken.

FIG. 1B is an example of a ransomware detection system, according to some embodiments. Ransomware detection system 100b represents an anomaly detection data flow within network-based computing environment 100a. As shown in FIG. 1B, the sub-components of computing environment 110 presented in FIG. 1A are emphasized in greater detail to form the ransomware detection system 100b. Furthermore, the exemplary ransomware detection system 100b utilizes one or more files streamed into computing environment 110 from user device 160 via backup data stream 10.

In some embodiments, as described by environment 100a, user device 160 may initiate backup data stream 10 to computing environment 110. Resource backup component 115 may receive files from backup data stream 10. For example, resource backup component 115 may receive files from backup data stream 10 through an interface, such as an API. Resource backup component 115 may further include backup extension 117a and update extension 117b. Backup extension 117a may be the interface configured to receive the files of backup data stream 10 from user device 160. Update extension 117b may be configured to receive files from backup extension 117a and perform specific operations to determine statistics corresponding to the incoming files of backup data stream 10. For example, update extension 117b can determine a number of high entropy files, a number of files deleted, altered, or replaced, or a combination thereof. The statistics may also correspond to a specific file and include the entropy of the file, a flag indicating the file was deleted, altered, or replaced, or a combination thereof. These statistics may also be referred to as an observation of the file(s) of backup data stream 10.

In some embodiments, after backup extension 117a and update extension 117b perform the aforementioned operations, resource backup component 115 may forward the file(s) of backup data stream 10 and the determined observation data to ransomware detection engine 120. For example, update extension 117b may be configured to forward a file from backup data stream 10 and its respective observation data to data processing component 125 of the ransomware detection engine 120. The data processing component 125 may include two additional subcomponents: a threat evaluation handler 125a and the threat result handler 125b.

In some embodiments, the threat evaluation handler 125a may be a queue, API, or comparable mechanism for interfacing data of backup data stream 10 from resource backup component 115 to tracking component 130. Similarly, threat result handler 125b may be a queue, API, or comparable mechanism for interfacing files of backup data stream 10 from tracking component 130 to administrator device 170 or backup storage 180.

In some embodiments, tracking component 130 performs operations to identify whether a file, or multiple files, of backup data stream 10 have been encrypted by ransomware. In some embodiments, tracking component 130 may be configured with subcomponents to evaluate and perform further operations related to anomaly detection. For example, tracking component 130 may be further configured with subcomponents threat evaluation lambda 130a and threat result lambda 130b.

In some embodiments, threat evaluation lambda 130a may be a machine learning model within tracking component 130. For example, threat evaluation lambda 130a may refer to a computing service configured to build and run applications and backend services within computing environment 110. The machine learning model may be a random cut forest model. Threat evaluation lambda 130a may receive a serialized file from threat evaluation handler 125a and perform operations thereto. For example, threat evaluation lambda 130a may track byte distributions of the file(s) entering computing environment 110. After the bytes are tracked, threat evaluation lambda 130a may execute an entropy calculation based on the byte distribution.

In some embodiments, the threat evaluation lambda 130a may output an anomaly score related to the calculated entropy of the file of backup data stream 10. For example, threat evaluation lambda 130a may apply a statistical test, such as a chi squared scoring equation, to the byte distribution of the file. Therefore, threat evaluation lambda 130a may calculate an entropy of the file that is reflected by an anomaly score. Threat evaluation lambda 130a may use the anomaly score to identify whether a file is encrypted by ransomware. For example, in the case of perfectly random data stored on a file system and streamed into computing environment 110, the entropy calculation of threat evaluation lambda 130a would predict an equal occurrence of each byte value. In the case of a crypto-ransomware detection, where the files are encrypted, threat evaluation lambda 130a may use the uniform byte distribution as an expected distribution and determine if there is a similar or substantially equal frequency of byte values between the expected distribution and the observed distribution. In some embodiments, the likelihood of a file being encrypted by ransomware has a strong correlation to the entropy of the file's bytes. Threat evaluation lambda 130a may perform operations including determining a confidence threshold level of entropy to inferring whether a particular anomaly score underscores a ransomware attack.

In some embodiments, threat evaluation lambda 130a may be able to correlate the file and its respective observation data with a particular machine learning model utilized by tracking component 130. Threat evaluation lambda 130a may be configured to facilitate ransomware evaluations in parallel, thereby enabling the system to horizontally scale and handle an uptick in ransomware evaluation requests without delaying the time to detection for any one evaluation Threat evaluation lambda 130a may retrieve the serialized state of a machine learning model of tracking component 130. The retrieved serialized state of the machine learning model may be the most recent version or any prior version. In some embodiments, threat evaluation lambda 130a may be able to initialize a new machine learning model with a deserialized state. The deserialized machine learning model may reflect an entirely new version of a machine learning model or a new version based on the latest machine learning model of tracking component 130. Therefore, tracking component 130 may perform ransomware detection operations and train the machine learning model(s) included therein.

In some embodiments, tracking component 130 may be configured to communicate with training data storage 135. Training data storage 135 may be configured within computing environment 110 or external to computing environment 110. Training data storage 135 may refer to, but is not limited to, a database within a cloud computing environment or a persistent storage environment.

In some embodiments, training data storage 135 may house previous versions of the machine learning model used by tracking component 130. For example, tracking component 130 may be configured to query training data storage 135 for a most recent version of a machine learning model. Specifically, threat evaluation lambda 130a may query training data storage 135 for an existing machine learning model(s) tailored to evaluate a particular file type. Training data storage 135 may return the appropriate machine learning model, such as a particular random cut forest model, to tracking component 130.

In some embodiments, training data storage 135 may also contain historical observation data relating to each machine learning model version. The historical observation data may be used to train or otherwise initialize the machine learning model(s) of tracking component 130. For example, the machine learning model of tracking component 130 may be able to identify whether a particular file has been encrypted by ransomware based on past observations of files encrypted by ransomware.

In some embodiments, based on an analysis of the file, tracking component 130 may save the observation data and/or a new version of the machine learning model to training data storage 135 by way of serializing the model state to text format, including but not limited to a JSON format.

In some embodiments, tracking component 130 may forward the results of the ransomware detection operations back to data processing component 125. For example, threat evaluation lambda 130a may be configured to communicate the results of its ransomware detection operations—including if a file was encrypted by ransomware—to threat result handler 125b. Threat result handler 125b may write the results of the threat evaluation lambda 130a to a control plane database. By writing the results of a received threat evaluation lambda 130a to a control plane, computing environment 110 may be able to easily forward files to backup data storage 180 and administrator device 170. Specifically, threat result handler 125b may queue determinations made by the threat evaluation lambda 130a—via an interface—to threat result lambda 130b. In some embodiments, the threat result handler 125b may be a queue, API, or comparable mechanism for interfacing data.

In some embodiments, tracking component 130 may be configured to communicate the results of the ransomware detection operations to administrator device 170. For example, threat result lambda 130b may create a ransomware incident if a file (or some number of files) is identified to be encrypted by ransomware, as determined by threat evaluation lambda 130a. The ransomware incident may indicate that a file is encrypted by ransomware and suggest subsequent recommended actions, such as an indication that the affected file(s) should be quarantined and the user's access temporarily suspended to prevent further impact.

In some embodiments, tracking component 130 may be configured to communicate ransomware determinations to backup storage 180. For example, if threat evaluation lambda 130a identifies that a file is encrypted by ransomware, threat result lambda 130b may transmit the file to and/or log the created ransomware incident in backup storage 180. Furthermore, if threat result lambda 130b determines that a file is not encrypted by ransomware, threat result lambda 130b may transmit the file to backup storage 180.

In some embodiments, administrator device 170 may be configured to receive ransomware incidents from tracking component 130. Additionally, administrator device 170 may be configured to query tracking component 130 for whether a particular file is encrypted by ransomware. Tracking component 130, through threat evaluation lambda 130a, may use the machine learning model(s) to determine whether the file has been encrypted by ransomware. In some embodiments, the determination from threat evaluation lambda 130a may specify a likelihood that the file has been encrypted by ransomware. Based on this determination, threat result lambda 130b may relay the ransomware determination, such as a ransomware likelihood, back to administrator device 170 via an API or comparable interface mechanism.

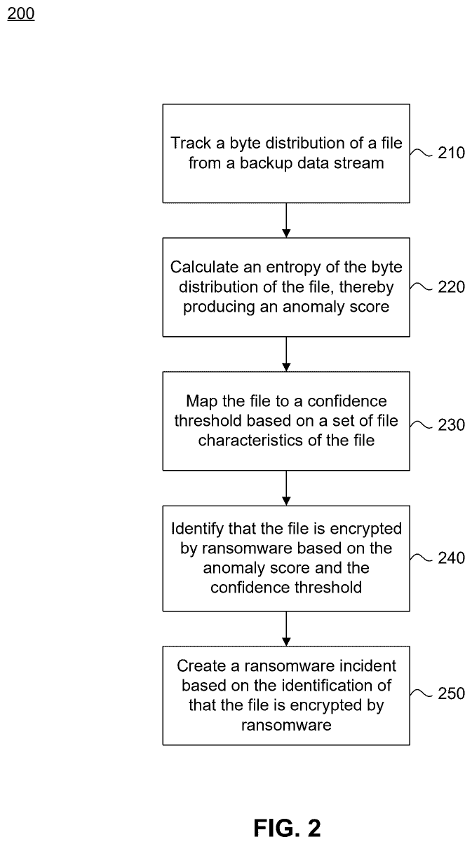

FIG. 2 illustrates a flowchart for method 200 for synchronously detecting a ransomware incident in a backup data stream, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIGS. 1A and 1B. However, method 200 is not limited to those example embodiments.

In 210, tracking component 130 may track a byte distribution of a file from backup data stream 10. For example, user device 160 may initiate backup data stream 10 into computing environment 110. Tracking component 130, through threat evaluation lambda 130a, may be able to track the byte distribution of the files streamed into computing environment 110. For example, threat evaluation lambda 130a may track the byte distribution of an entire file, specific segments of the byte distribution such as a file header (e.g., magic bytes) and the byte values associated with the file extension, or a combination thereof.

At 220, tracking component 130 may calculate an entropy of the byte distribution of the file, thereby producing an anomaly score of the file. For example, threat evaluation lambda 130a may calculate the entropy of the file. In some embodiments, file entropy refers to the compressibility of a file and the randomness its byte distribution. In some cases, the byte distribution of a file affected by ransomware will have a high entropy value, indicating that the byte distribution of the file is highly randomized. A low file entropy value indicates that the file's bytes are not evenly distributed and is likely not encrypted by ransomware. In some embodiments, the entropy of the file is reflected by an anomaly score. The anomaly score may be correlated to the entropy of the file. In some embodiments, tracking component 130 may determine an anomaly score by applying a statistical test to the byte distribution of the file. For example, a probability of a file being encrypted by ransomware may be directly correlated to the entropy of the file's bytes. In some embodiments, the statistical test is a chi squared probability algorithm.

At 230, tracking component 130 may map the file to a confidence threshold of a plurality of confidence thresholds based on a set of file characteristics of the file. For example, threat evaluation lambda 130a may map the file to a particular confidence threshold within a plurality of confidence thresholds. Threat evaluation lambda 130a may identify information related to the file, in addition to the entropy of the file. For example, threat evaluation lambda 130a may also extract a set of file characteristics which may include, but are not limited to, file type, file size, file extension, file age, file usage patterns, or a combination thereof. The set of file characteristics may not be limited to these example embodiments, as will be recognized by a person skilled in the art reading this disclosure. In some embodiments, threat evaluation lambda 130a may correlate the file to a resource type using the set of file characteristics and extracting the confidence threshold corresponding to the resource type. This, for example, allows for tracking component 130 to perform ransomware detection operations tailored to the context of the file. In some further embodiments, tracking component 130 may calculate an average anomaly score for one or more files correlated to a resource type over a number of previous days and define the confidence threshold to be within a number of standard deviations from the average anomaly score.

At 240, tracking component 130 may identify that the file is encrypted by ransomware based on the anomaly score and the confidence threshold. As determined in 230, the confidence threshold may specify a particular anomaly score or range of anomaly scores that indicates a file is not affected by ransomware. If the determined anomaly score falls outside of that particular anomaly score or anomaly score range, then tracking component 130 may identify that the file is encrypted by ransomware. For example, in some embodiments, tracking component 130 may identify that a file is encrypted by ransomware based on the anomaly score exceeding the confidence threshold. In some alternative embodiments, tracking component 130 may identify that a file is encrypted by ransomware based on the anomaly score falling below a confidence threshold. An identification that a file is encrypted by ransomware from tracking component 130 may not be limited to these example embodiments, as will be recognized by a person skilled in the art reading this disclosure. Tracking component 130 may execute multiple instances of threat evaluation lambda 130a to evaluate files for ransomware in parallel.

In some embodiments, tracking component 130 may employ a machine learning model to identify whether the file is encrypted by ransomware. For example, threat evaluation lambda 130a may utilize a machine learning model to identify that the file is encrypted by ransomware. The identification may be influenced by the context of the file. For example, the context of the file may relate to a type of ransomware attack, the file extension, or a combination thereof. In some embodiments, threat evaluation lambda 130a may evaluate the file for a particular ransomware attack of a set of ransomware attacks, in which the set of ransomware attacks may include in-place encryption ransomware or delete-and-replace ransomware. For example, in-place encryption ransomware encrypts a file prior to the backup data stream and delete-and-replace encryption ransomware deletes an original file and replaces the file with an encrypted version before backup data stream 10 is initiated. In some embodiments, the identification may be influenced by the file extension of the file. For example, threat evaluation lambda 130a may compare the file extension with a predefined set of extensions associated with ransomware attacks, including but not limited to “.lockbit” and “.zcrypt.”

In some embodiments, certain types of ransomware attacks may resemble previous instances of ransomware attacks. Threat evaluation lambda 130a may retrieve a previous number of days of observation data from training data storage 135 to evaluate and use the machine learning model to make an inference, based on the previous observation data mapped to the machine learning model in training data storage 135, as to whether the file is encrypted by ransomware.

At 250, tracking component 130 may create a ransomware incident based on the identification that the file is encrypted by ransomware. For example, ransomware result lambda 130b may create and send the ransomware incident to administrator device 170, based on an identification that the file is encrypted by ransomware. The ransomware incident may contain information such as, but not limited to, the file name, the file type, the file extension, the file size, the entropy of the file, the calculated anomaly score of the file, the execution date of the backup data stream 10, or a combination thereof. The ransomware incident may not be limited to these example embodiments, as will be recognized by a person skilled in the art reading this disclosure. Furthermore, threat result lambda 130b may log the created ransomware incident in backup storage 180. Threat result lambda 130b may transmit the file to a sub-component of backup storage 180 for files encrypted by ransomware. In some embodiments, if threat evaluation lambda 130a determines that a file is not encrypted by ransomware, threat result lambda 130b may transmit the file to backup storage 180. In such embodiments, threat result lambda 130b may transmit a message to administrator device 170 that the file is not encrypted by ransomware.

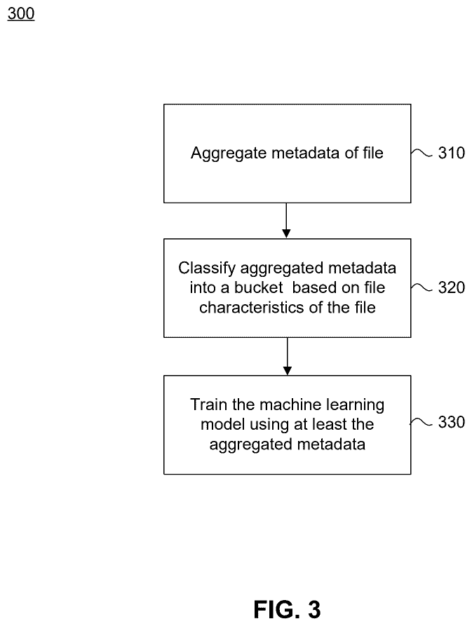

FIG. 3 illustrates a flowchart for method 300 for training a machine learning model during the detection of a ransomware incident, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1A and 1B and method 200. However, method 300 is not limited to those example embodiments.

At 310, tracking component 130 may aggregate the metadata of the file. For example, threat evaluation lambda 130a may aggregate the metadata of a file from backup data stream 10. The aggregated metadata may include, but is not limited to, file size, file extension, file type, the anomaly score of the file, or a combination thereof. The aggregated metadata may be reflected as a data object.

At 320, tracking component 130 classifies the aggregated metadata of the file into a bucket based on one or more file characteristics of the file. For example, threat evaluation lambda 130a may classify the aggregated metadata into a bucket based on file characteristics such as, but not limited to, file type and file size. For example, threat evaluation lambda 130a may select one or more of these file characteristics from a set of file characteristics recognizable by ransomware detection engine 120. In some embodiments, file type may be reflected by the file extension of the file. Tracking component 130 may classify the aggregated metadata by storing the aggregated metadata in training data storage 135. For example, threat evaluation lambda 130a may store the aggregated metadata of the file in a bucket within training data storage 135. Threat evaluation lambda 130a may store the aggregated metadata contemporaneously with 240 of FIG. 2. A bucket may refer to a data table within a data model. In some embodiments, the bucket may reside within a cloud storage database, wherein the aggregated metadata is stored as an object.

At 330, tracking component 130 may train the machine learning model of the ransomware detection engine 120 using at least the aggregated metadata of the file. In some embodiments, as discussed above, the machine learning model(s) of ransomware detection engine 120 may be configured within the tracking component 130 or externally. For example, threat evaluation lambda 130a may update the machine learning model based on the aggregated metadata. For future ransomware detection operations, threat evaluation lambda 130a may use at least the aggregated metadata to improve the ransomware inferences and subsequent identifications made by the machine learning model. In some embodiments, machine learning model may be trained on additional historical aggregated metadata of a bucket, wherein the historical aggregated metadata shares the one or more file characteristics of the aforementioned aggregated metadata of 320. For example, this may be based on file type, file size, or a combination thereof. The file characteristics described herein are not limited to these types of embodiments, as will be recognized by a person skilled in the art reading this disclosure

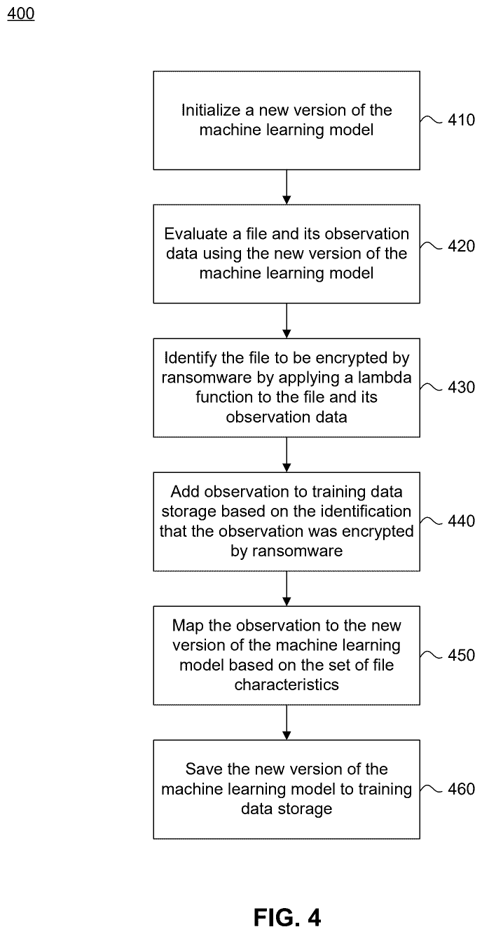

FIG. 4 illustrates a flowchart for method 400 for updating the machine learning models of a ransomware detection engine, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1A and 1B. However, method 400 is not limited to those example embodiments.

At 410, tracking component 130 may initialize a new version of a machine learning model. For example, threat evaluation lambda 130a may query training data storage 135 for a previous version of a machine learning model. The previous version of the machine learning model may be the most recent version or any historical version of the machine learning model in training data storage 135. The retrieved machine learning model may serve a new version for the machine learning model.

At 420, tracking component 130, using the new version of the machine learning model, may evaluate a file and its observation data from backup data stream 10. For example, threat evaluation lambda 130a may receive an observation and the respective observation data contained therein determined by resource backup component 115. As stated above, an observation may refer to a set of statistics including a number of high-entropy files, a number of deleted, altered, or replaced files, a number of files with extensions known to be associated with a ransomware attack, or a combination thereof. An observation may also correspond to a specific file and include the entropy of the file, a flag indicating the file was deleted, altered, or replaced, or a combination thereof. Threat evaluation lambda 130a may evaluate the file and its respective observation data by performing similar operations as described in 220 and 230.

In some embodiments, tracking component 130 may identify the file extension(s) of data streamed into computing environment 110 via data backup stream 10. The file extension may be compared with a predefined set of extensions that are known to be associated with ransomware attacks, including but not limited to “.lockbit” and “.zcrypt.” This comparison may be applied by tracking component, using the new version of the machine learning model, to further evaluate a file and its respective observation data,

At 430, tracking component 130, based on 420, may identify the file to be encrypted by ransomware by applying threat evaluation lambda 130a to the file and its observation data. For example, threat evaluation lambda 130a may identify that the file is a ransomware encrypted file based on operations described in 240, comparing the file extension with the predefined set of extensions associated with ransomware attacks, or a combination thereof.

At 440, tracking component 130 may add the observation to training data storage 135 based on the identification that the file was encrypted by ransomware. For example, threat evaluation lambda 130a may store the observation in training storage 135 as a data object. In some embodiments, tracking component 130 may additionally remove stale observations. For example, threat evaluation lambda 130a may prune stale observations in training data storage 135 after a particular period of time elapsed. In some embodiments, the particular period of time may be three months.

At 450, tracking component 130 may map the observation to the new version of the machine learning model based on the set of file characteristics. For example, threat evaluation lambda 130a may map the observation to a new version of the machine learning model based on the type and size of the file. This may allow for a particular version of a machine learning model to be tailored to evaluate files of a particular resource type. For example, the machine learning model may provide more accurate inferences and identifications of ransomware in a file from backup data stream 10 if is trained on a particular resource type. In some embodiments, tracking component 130 may be configured to employ multiple machine learning models directed towards multiple resource types. For example, threat evaluation lambda 130a may train a particular machine learning model to evaluate and identify ransomware in text files for a particular tenant, specifically. In some embodiments, tracking component 130 may map the observation, as well as previous observations, to the new version of the machine learning model, thereby enabling the machine learning model to be trained iteratively on historical observations.

At 460, tracking component 130 saves the new version of the machine learning model to the training data storage 135. For example, threat evaluation lambda 130a may save the new version of the machine learning mode to training data storage 135—by way of serializing the model state to text format, including, but not limited to, a JSON format—contemporaneously with the operations of 250.

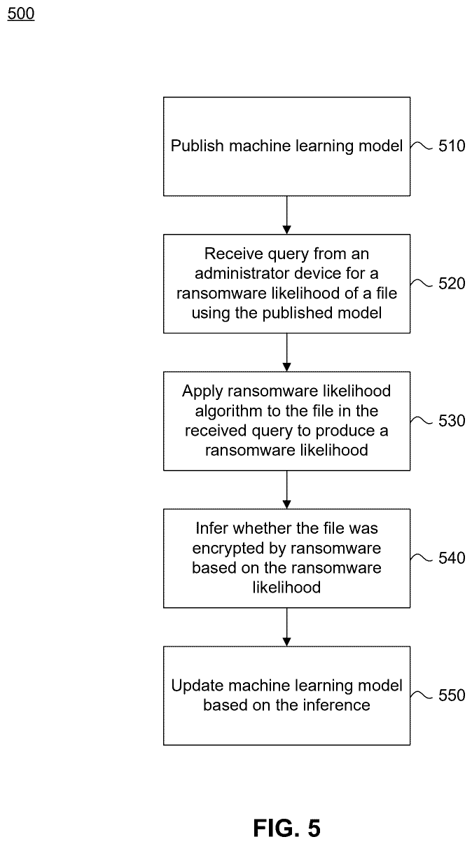

FIG. 5 illustrates a flowchart for method 500 for training a machine learning model through client queries, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1A and 1B. However, method 500 is not limited to those example embodiments.

At 510, ransomware detection engine 120 may publish a machine learning model. In some embodiments, ransomware detection engine 120 may be configured to communicate with external devices, such as administrator device 170, via an application programming interface (API). The API may be configured such that administrator device 170 can send files to the machine learning model published by ransomware detection engine 120. The file type, may be any file type known to one skilled in the art readable by computing systems.

At 520, ransomware detection engine 120 may receive a query from an administrator device, such as administrator device 170, for a ransomware likelihood of a file using the published machine learning model. The query may resemble an API request containing one or more files. In some embodiments, the query may also request a likelihood of whether a file is encrypted by ransomware. In some other embodiments, the query may specify whether a particular file, sent from administrator device 170, is encrypted with ransomware. If the query reflects this particular embodiment, ransomware detection engine 120 may apply method 200 to detect a ransomware incident. Otherwise, the flow continues to 530.

At 530, ransomware detection engine 120 may apply a ransomware likelihood algorithm to the file in the received query to produce a ransomware likelihood. In some embodiments, threat evaluation lambda 130a of tracking component 130 may, based on size and extension for the file of the query (e.g., the API request), may calculate an entropy of the file, which is thereby reflected by an anomaly score. Threat evaluation lambda 130a may subsequently apply a statistical test to the byte distribution of the file, such as a chi squared scoring algorithm, to determine the anomaly score. In some embodiments, tracking component 130 may calculate an average anomaly score for one or more files previously queried by administrator device 170 that are of the same file type, file size, or a combination thereof. Tracking component 130 may also define a confidence threshold to be within a number of standard deviations from the average anomaly score. For example, threat evaluation lambda 130a may calculate a range of standard deviations from a mean anomaly score of previous files based on similar file characteristics, such as file type, file size, or a combination thereof. Additionally, threat evaluation lambda 130a may determine the Z-Score of the respective anomaly score compared to the average anomaly score.

At 540, tracking component 130 may infer that the file sent from administrator device 170 is encrypted by ransomware based on the ransomware likelihood. In some embodiments, tracking component 130 may determine that the file is encrypted by ransomware if its anomaly is outside of the range of standard deviations determined in 530. For example, threat evaluation lambda 130a may mark the file suspicious of ransomware encryption if the Z-Score is less than a threshold score (e.g., without limitation, −2.5). Additionally, threat evaluation lambda 130a may compare the file extension with a predefined set of file extensions that are known to be associated with ransomware attacks, including but not limited to “.lockbit” and “.zcrypt.” In some embodiments, threat evaluation lambda 130a may specify a likelihood, in the form of a percentage, that the file is encrypted by ransomware based on the Z-score of the file, the file extension, or a combination thereof. Tracking component 130, through threat result lambda 130b, may output the likelihood to the client, such as administrator device 170.

In some embodiments, tracking component 130 may infer that the file sent from administrator device 170 is not encrypted by ransomware based on the ransomware likelihood. For example, tracking component 130a may determine that the anomaly score is within the range of standard deviations determined in 530. In some other embodiments, threat evaluation lambda 130a may specify a likelihood that the file is not encrypted by ransomware based on the Z-Score of the file, its file extension, or a combination thereof.

At 550, tracking component 130 may update the machine learning model based on the inference of 540. For example, in response to inferring whether the file is encrypted by ransomware, threat evaluation lambda 130a may aggregate the metadata of the file, including but not limited to, file size, file type, the anomaly score of the file, or a combination thereof, and store the aggregated metadata in training data storage 135. Subsequently, threat evaluation lambda 130a may classify metadata into a particular bucket in training data storage 135 which may be used to train the further training the machine learning models of the machine learning system of the ransomware detection engine 120.

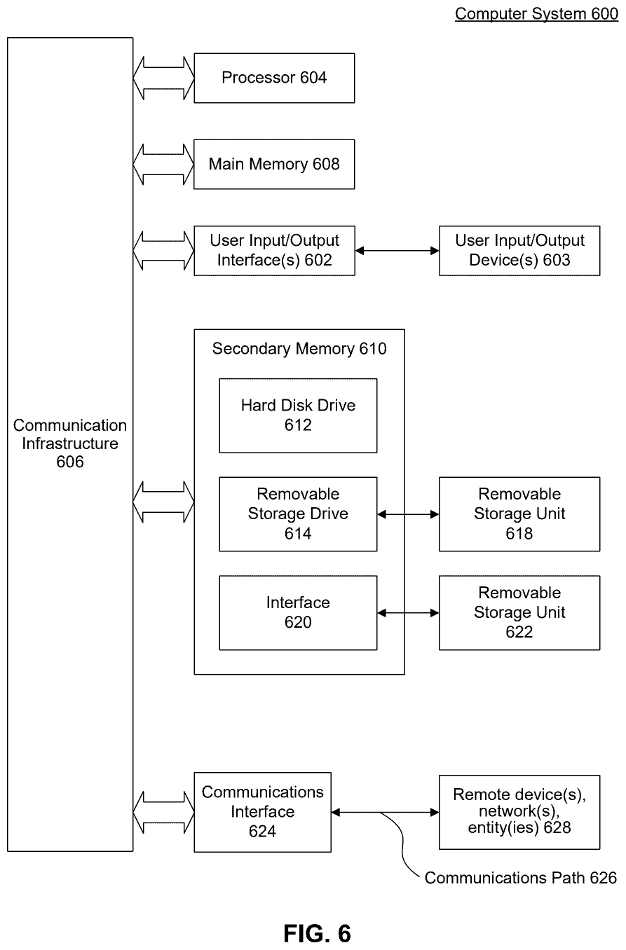

FIG. 6 illustrates a diagram of a general-purpose computer that can be used to perform various embodiments of the present disclosure, according to some embodiments. Various embodiments can be implemented, for example, using one or more well-known computer systems, such as computer system 600 shown in FIG. 6. One or more computer systems 600 can be used, for example, to implement any embodiment of the disclosure discussed herein, such ransomware detection system 100b, as well as any combinations and sub-combinations thereof.

Computer system 600 can include one or more processors (also called central processing units, or CPUs), such as a processor 604. Processor 604 can be connected to a communication infrastructure or bus 606.

Computer system 600 can also include customer input/output device(s) 603, such as monitors, keyboards, pointing devices, etc., which can communicate with communication infrastructure 606 through customer input/output interface(s) 602.

One or more of processors 604 can be a graphics processing unit (GPU). In an embodiment, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 600 can also include a main or primary memory 608, such as random access memory (RAM). Main memory 608 can include one or more levels of cache. Main memory 608 can have stored therein control logic (i.e., computer software) and/or data.

Computer system 600 can also include one or more secondary storage devices or memory 610. Secondary memory 610 can include, for example, a hard disk drive 612 and/or a removable storage device or drive 614. Removable storage drive 614 can be a floppy disk drive, a magnetic tape drive, a compact disk drive, an optical storage device, tape backup device, and/or any other storage device/drive.

Removable storage drive 614 can interact with a removable storage unit 618. Removable storage unit 618 can include a computer usable or readable storage device having stored thereon computer software (control logic) and/or data. Removable storage unit 618 can be a floppy disk, magnetic tape, compact disk, DVD, optical storage disk, and/any other computer data storage device. Removable storage drive 614 can read from and/or write to removable storage unit 618.

Secondary memory 610 can include other means, devices, components, instrumentalities or other approaches for allowing computer programs and/or other instructions and/or data to be accessed by computer system 600. Such means, devices, components, instrumentalities or other approaches can include, for example, a removable storage unit 622 and an interface 620. Examples of the removable storage unit 622 and the interface 620 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Computer system 600 can further include a communication or network interface 624. Communication interface 624 can enable computer system 600 to communicate and interact with any combination of external devices, external networks, external entities, etc. (individually and collectively referenced by reference number 628). For example, communication interface 624 can allow computer system 600 to communicate with external or remote devices 628 over communications path 626, which can be wired and/or wireless (or a combination thereof), and which can include any combination of LANs, WANs, the Internet, etc. Control logic and/or data can be transmitted to and from computer system 600 via communication path 626.

Computer system 600 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some embodiments, a tangible, non-transitory apparatus or article of manufacture including a tangible, non-transitory computer useable or readable medium having control logic (software) stored thereon can also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), can cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References herein to “one embodiment,” “an embodiment,” “an example embodiment,” “some embodiments,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

These and other valuable aspects of the embodiments of the present disclosure consequently further the state of the technology to at least the next level. While the disclosed embodiments have been described as the best mode of implementing the methods and systems for per-resource anomaly detection, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the breadth and scope of this disclosure should not be limited by any of the above-described exemplary embodiments, but should be defined only in accordance with the following claims and their equivalents.

What is claimed is:

1. A computer-implemented method for detecting a ransomware incident in a backup data stream, the computer-implemented method comprising:
tracking a byte distribution of a file from the backup data stream;
calculating an entropy of the byte distribution of the file, wherein the entropy is reflected by an anomaly score for the file;
mapping the file to a confidence threshold of a plurality of confidence thresholds based on a set of file characteristics of the file;
identifying, by a machine learning model, that the file is encrypted by ransomware based on the anomaly score of the file exceeding the confidence threshold; and
creating the ransomware incident based on the identifying that the file is encrypted by the ransomware.

2. The computer-implemented method of claim 1, further comprising:
aggregating metadata of the file, wherein the metadata comprises file size, file extension, file type, or the anomaly score of the file;
classifying the aggregated metadata of the file into a bucket of a plurality of buckets based on one or more file characteristics selected from the set of file characteristics, wherein the bucket comprises aggregated metadata of another file; and
training the machine learning model using at least the aggregated metadata in the bucket.

3. The computer-implemented method of claim 1, wherein the identifying comprises:
evaluating the file for a particular ransomware attack of a set of ransomware attacks, wherein the set of ransomware attacks comprises in-place encryption ransomware or delete-and-replace ransomware.

4. The computer-implemented method of claim 1, wherein the machine learning model comprises a random cut forest model.

5. The computer-implemented method of claim 1, wherein the calculating comprises:
applying a chi square entropy scoring equation on the byte distribution.

6. The computer-implemented method of claim 1, wherein the mapping comprises:
correlating the file to a resource type using the set of file characteristics, wherein the set of file characteristics comprises file type, file size, file age, file extension, or file usage; and
extracting the confidence threshold corresponding to the resource type.

7. The computer-implemented method of claim 6, wherein the extracting comprises:
calculating an average anomaly score for one or more files correlated to the resource type over a number of previous days; and
defining the confidence threshold to be within a number of standard deviations from the average anomaly score.

8. A system for detecting a ransomware incident in a backup data stream, the system comprising:
one or more memories;
at least one processor each coupled to at least one of the memories and configured to perform operations comprising:
tracking a byte distribution of a file from the backup data stream;
calculating an entropy of the byte distribution of the file, wherein the entropy is reflected by an anomaly score for the file;
mapping the file to a confidence threshold of a plurality of confidence thresholds based on a set of file characteristics of the file;
identifying, by a machine learning model, that the file is encrypted by ransomware based on the anomaly score of the file exceeding the confidence threshold; and
creating the ransomware incident based on the identifying that the file is encrypted by the ransomware.

9. The system of claim 8, wherein the operations further comprise:
aggregating metadata of the file, wherein the metadata comprises file size, file extension, file type, or the anomaly score of the file;
classifying the aggregated metadata of the file into a bucket of a plurality of buckets based on one or more file characteristics selected from the set of file characteristics, wherein the bucket comprises aggregated metadata of another file; and
training the machine learning model using at least the aggregated metadata in the bucket.

10. The system of claim 8, wherein the identifying comprises:
evaluating the file for a particular ransomware attack of a set of ransomware attacks, wherein the set of ransomware attacks comprises in-place encryption ransomware or delete-and-replace ransomware.

11. The system of claim 8, wherein the machine learning model comprises a random cut forest model.

12. The system of claim 8, wherein the calculating comprises:
applying a chi square entropy scoring equation on the byte distribution.

13. The system of claim 8, wherein the mapping comprises:
correlating the file to a resource type using the set of file characteristics, wherein the set of file characteristics comprises file type, file size, file age, file extension, or file usage; and
extracting the confidence threshold corresponding to the resource type.

14. The system of claim 13, wherein the extracting comprises:
calculating an average anomaly score for one or more files correlated to the resource type over a number of previous days; and
defining the confidence threshold to be within a number of standard deviations from the average anomaly score.

15. A non-transitory computer-readable device having instructions stored thereon that, when executed by at least one computing device, causes the at least one computing device to perform operations for detecting a ransomware incident in a backup data stream, the operations comprising:
tracking a byte distribution of a file from the backup data stream;
calculating an entropy of the byte distribution of the file, wherein the entropy is reflected by an anomaly score for the file;
mapping the file to a confidence threshold of a plurality of confidence thresholds based on a set of file characteristics of the file;
identifying, by a machine learning model, that the file is encrypted by ransomware based on the anomaly score of the file exceeding the confidence threshold; and
creating the ransomware incident based on the identifying that the file is encrypted by the ransomware.

16. The non-transitory computer readable device of claim 15, the operations further comprising:
aggregating metadata of the file, wherein the metadata comprises file size, file type, file extension, or the anomaly score of the file;
classifying the aggregated metadata of the file into a bucket of a plurality of buckets based on one or more file characteristics selected from the set of file characteristics, wherein the bucket comprises aggregated metadata of another file; and
training the machine learning model using at least the aggregated metadata in the bucket.

17. The non-transitory computer readable device of claim 15, wherein the identifying comprises:
evaluating the file for a particular ransomware attack of a set of ransomware attacks, wherein the set of ransomware attacks comprises in-place encryption ransomware or delete-and-replace ransomware.

18. The non-transitory computer readable device of claim 15, wherein the machine learning model comprises a random cut forest model.

19. The non-transitory computer readable device of claim 15, wherein the calculating comprises:
applying a chi square entropy scoring equation on the byte distribution.

20. The non-transitory computer readable device of claim 15, wherein the mapping comprises:
correlating the file to a resource type using the set of file characteristics, wherein the set of file characteristics comprises file type, file size, file age, file extension, or file usage; and
extracting the confidence threshold corresponding to the resource type.
